(19) United States
(12) Patent Application Publication
(10) Pub. No.: US 2026/0075256 A1
(43) Pub. Date: Mar. 12, 2026

(54) CODING-LOOP-EXTERNAL SMOOTHING OF A BOUNDARY BETWEEN TWO IMAGE REGIONS

(71) Applicant: S.A. VITEC, Paris (FR)

(72) Inventors: Elie MORA, MALAKOFF (FR); Jean-Marc THIESSE, CHATILLON (FR)

(73) Assignee: S.A. VITEC, Paris (FR)

(21) Appl. No.: 19/106,273

(22) PCT Filed: Aug. 8, 2023
(86) PCT No.: PCT/FR2023/051258

§ 371 Date: Feb. 25, 2025

(30) Foreign Application Priority Data
Aug. 25, 2022 (FR) FR2208524

(51) Int. Cl. H04N 19/86; H04N 19/117; H04N 19/17; H04N 19/196

(52) U.S. Cl. CPC H04N 19/86; H04N 19/17; H04N 19/196; H04N 19/117

(57) ABSTRACT

A method for processing at least one decoded image region. At the exit of a decoding loop that has decoded at least one current image region, the decoded current image region is processed with the aid of a boundary-smoothing module that uses metadata relating at least to a boundary between the current image region and a neighboring image region.

### TECHNICAL FIELD

This disclosure relates to the field of video compression.

More particularly, this disclosure relates to a method for processing at least one decoded image region, as well as relating to a computer program, a storage medium, a digital signal, and a data processing circuit.

### BACKGROUND

Standardized video compression techniques have been based on the same principles since the first generation of MPEG standards, MPEG-2. In chronological order, the subsequent standards were H.264/AVC (2003), HEVC (2013), and VVC (2020). The AOM, VP9, and AV1 coding techniques also follow the same concepts.

A video sequence to be encoded is divided into images. Each image is divided into fixed-size blocks that in turn may subsequently be divided. For a given image, an encoder processes the blocks sequentially, from the block located at the top left of the image to the block located at the bottom right of the image. The encoder generates a binary signal as output, comprising, for each image, the result of sequentially processing the constituent blocks.

The binary signal containing the video sequence thus compressed can then be sent out and processed by a decoder in which the operation, modeled on that of the encoder, considers the blocks sequentially in order to reconstruct the initial video sequence.

Reference is now made to FIG. 1, which represents an example of a HEVC encoder built around a coding loop configured to perform different processing operations on a block of a source video sequence 100 provided as input to the encoder.

One of these processing operations is a prediction of the block provided, using information already encoded and decoded. The first image, referred to as “Intra”, is encoded with spatial prediction 118 using only reconstructed pixels in the vicinity of the block currently being processed. The subsequent images, referred to as “Inter”, can use spatial prediction as well as a temporal prediction 116 which makes use of images previously encoded with the aid of motion compensation 114 signaled by a motion vector and which generally allows very efficient prediction. The images thus encoded then decoded and used for encoding future images are grouped in a memory referred to as the “Decoded Picture Buffer” (DPB) 112.

Other processing carried out in the coding loop includes coding the difference between the result of the prediction and the block provided as input, or “residual pixels”. This coding is carried out after a transformation and quantization step 104. The quantization step is carried out for a given quantization parameter (QP) associated with each block and signaled in the bit stream. QP represents a compromise between the desired image quality after decoding and the desired degree of video compression. The higher the QP value, the lower the amount of information relating to the residual pixels in the encoded video sequence, and the higher the degree of video compression of the encoded video sequence. Conversely, the lower the QP value, the greater the amount of information relating to the residual pixels, and the better the quality of the reconstruction at the decoder receiving the encoded video sequence. An inverse quantization and transformation step is used to reconstruct the residual pixels.

Other processing operations carried out in the coding loop include successive filterings of the block being processed, by different filters. The HEVC standard provides two filters, referred to as “Sample Adaptive Offset” (SAO) 108 and “Deblocking Filter” 110. These filters modify the reconstructed pixels of the block being processed without impacting the prediction of neighboring blocks within the same image, but impacting the prediction of future blocks within subsequent images since the images in the DPB are post-filtering images. In addition to these two filters, the VVC standard introduced an additional filter referred to as an “Adaptive Loop Filter” (ALF).

As has already been explained, the encoder thus generates as output a binary signal 124 comprising, for each image, the result of sequentially processing its component blocks.

Transversally to such processing, various high-level image subdivisions have been introduced into the standards in order to address different applications: for example, “Slices” and “Tiles” according to the HEVC standard, and sub-images or “SubPictures” according to the VVC standard. These examples of subdivisions are described in particular in nplcit1. FIG. 2 shows an example of subdividing an image 200 according to the VVC standard into Tiles (delimited by thick solid lines) and Slices (delimited by thick dotted lines). In that example, the image is also divisible into blocks or “CTUs” (coding tree units), indicated with thin lines.

One of the main uses of high-level image subdivisions concerns applications involving a large number of pixels to be encoded. We can cite, for example, the encoding of video sequences at high image resolutions (4K, 8K, or 16K for example), video sequences at a high frame rate (greater than 60 fps for example), or 360° video sequences as are used for example in virtual reality applications.

High-level image subdivisions, for example into Tiles, are used in HEVC to allow parallel processing across several encoding cores, for example by planning to process one Tile per encoding core, and thus provide a response to the high number of calculations required with limited or even zero data sharing between encoding cores. Parallel processing can make use of several threads or several cores of one or more data processing circuits, which for example may be CPU, ASIC, or FPGA circuits.

Generally, the video stream thus compressed is decoded by a decoder acting on a single decoding core and not having any knowledge of the parallelism implemented during encoding. Decoding in several decoding cores is nevertheless also conceivable.

It is possible, in the HEVC standard, to implement processing in the coding loop so as to improve the visual quality between neighboring Tiles, namely sharing information between encoding cores about the pixels at the boundaries between Tiles, and, within each encoding core, performing specific processing at the boundaries. As for the filters, for example SAO and deblocking filters, normative parameters may be provided in the encoded video sequence, to indicate whether or not these filters have been utilized within the coding loop to encode a given Slice or Tile. In the HEVC standard, these parameters are referred to as “loop_filter_across_slice” and “loop_filter_across_tile”. The concept of the Motion Constrained Tile Set (MCTS), which relates to these specific modifications, is described in nplcit2. MCTS is a set of measures taken in the encoder to make the encoding/decoding of each tile independent of the encoding/decoding of other tiles. It thus allows parallelization of at least the prediction and reconstruction processing. In addition, a parameter referred to as “loop_filter_across_tile” and which can take the values of “0” or “1” allows indicating whether parallelization can be extended to boundary filtering processes (case of the value “0”), or whether, on the contrary, the boundary filtering processes require data relating to the coding/decoding of adjacent tiles (case of the value “1”).

The VVC standard has also introduced sub-images referred to as “subpictures”, intended to replace the MCTS. These sub-images are designed to be respectively processed by a respective encoding core in a completely independent manner. Several contributions such as nplcit3 have been made by standardization parties, resulting in this design in the VVC standard.

Regardless of which high-level subdividing is concerned, it is desirable to be able to smooth, at the decoder, the boundaries between Tiles, Slices, or sub-images that have been processed by different encoding cores. Indeed, an absence of smoothing leads to, post-decoding, the boundaries being visible and visually unsettling.

With the current architecture of video compression standards, it is only possible to apply boundary smoothing at the decoder level with no risk of drift if this smoothing has previously been applied at the encoder. Thus, when boundary smoothing is applied at the encoder, the VVC standard provides for signaling in the bitstream, by means of a parameter referred to as “sps_loop_filter_across_subpic_enabled_flag”, that this boundary smoothing is to be reapplied at the decoder.

Furthermore, when considering a boundary between two neighboring Tiles, Slices, or sub-images, where one of them was encoded by a first encoding core and the other by a second and different encoding core, boundary smoothing can only be implemented at the encoder if pixels are transferred either between the first and second encoding cores, or from the first and second encoding cores to a third encoding core dedicated to implementing boundary smoothing.

It follows from the above that, with the current architecture of video compression standards and in the case where encoding is implemented in parallel processing across several encoding cores, the applying of boundary smoothing induces significant constraints at the encoder.

To avoid these constraints, one may envisage signaling, in the bitstream, that boundary smoothing is to be performed at the decoder, without applying this smoothing at the encoder.

Such processing is asymmetrical, because it involves, in order to decode sub-images, applying a deblocking filter at the decoder to the boundaries of the sub-images, without a corresponding deblocking filter having also been applied to these boundaries at the encoder when encoding these same sub-images.

Such asymmetrical processing between encoder and decoder induces drift, which is initially small and limited to the pixels on either side of the boundary between two sub-images. The more successive inter-predictions there are, the more the drift increases. This drift can be minimized by prohibiting the activation, at the encoder as well as at the decoder, of the SAO and ALF filters at the CTUs at the boundaries. Nevertheless, even with such provisions, such drift can generate significant visual artifacts at the end of decoding.

To illustrate this aspect, a sequence of 60 images was encoded with the following operating procedure. Each image was previously divided into two halves separated by a vertical boundary. The left image halves were encoded by a first encoding core, and, in parallel, the right image halves were encoded by a second and different encoding core. No communication was set up between the two encoding cores, and no deblocking filter was implemented at the encoder. FIG. 3 shows the twentieth image 300, the fortieth image 302, and the sixtieth image 304 in the image sequence as obtained after decoding, aggregating the decoded image halves, and implementing a deblocking filter at the decoder only, in the decoding loop. Drift appears which is very significant from the fortieth image on, and continues to increase until it affects approximately three-quarters of the sixtieth image.

In order to preserve the processing at the encoder and decoder, one solution has been proposed (nplcit4) to allow filtering with no impact on decoding due to expectations from previous results. This approach is nevertheless costly in terms of computation time.

Finally, related work (nplcit5 and nplcit6) has been conducted within the framework of the JPEG 2000 image compression standard. Those authors introduce the concept of “detiling”, which involves, at the encoder, breaking down into wavelets the digital signals corresponding to groupings (in Tiles) of CTUs to be encoded. The authors also plan to apply filtering at the encoder in the wavelet transform domain.

### SUMMARY

This disclosure improves the situation.

A method for processing at least one decoded image region is proposed, the method comprising:
at the exit of a decoding loop that has decoded at least one current image region, processing the decoded current image region with the aid of a boundary smoothing module using metadata relating at least to a boundary between the current image region and a neighboring image region.

“Image region” is understood to mean any region delimited by a closed line within an image. When two closed lines each delimiting an image region have a common portion, this common portion forms a boundary between these image regions which are then said to be neighboring.

“Decoding loop” is understood to mean a set of logical instructions which at least allow:
receiving in encoded form, as input, a digital signal snippet relating to the current image region,
decoding the digital signal snippet at least on the basis of information already decoded by the decoding loop, this already decoded information relating for example to one or more other regions of the same image and/or to one or more other images,
providing, as output, the digital signal snippet in decoded form, also called the “decoded current image region”, and
storing the decoded current image region as information already decoded, usable for predicting image regions relating to future images.

“Metadata” is understood to mean digital data associated with the boundary between the current image region and a neighboring image region. The metadata is used, at least, for the processing implemented by the boundary smoothing module.

It is understood that, according to the proposed method, processing which uses the boundary smoothing module is carried out outside the decoding loop, and therefore the result of this processing does not impact any future decoding of image regions by the decoding loop. Thus, the proposed method makes it possible to perform boundary smoothing post-decoding while maintaining symmetry in the processing at the encoder and decoder. The proposed method therefore provides less visibility of the boundaries but without generating visual artifacts, hence less viewing discomfort by a viewer.

Furthermore, implementing the proposed method at the exit of the decoding loop does not require any modification of existing coding algorithms or devices. In particular, the proposed method is fully compatible with encoders making use of parallelization techniques by means of a plurality of encoding cores, an encoding core being responsible for encoding one image region among a set of image regions resulting from a high-level partitioning of an image.

In some examples, the decoded current image region comprises a bordering region corresponding to the boundary and a region distant from the boundary, and the processing of the decoded current image region comprises a processing of the bordering region and does not comprise a processing of the region distant from the boundary.

Thus, the processing of an image obtained by aggregating image regions output by the decoder may be limited to regions located at the boundaries between image regions, and without impacting the image as a whole. In other words, it is possible to implement processing that is differentiated by image region areas.

In some examples, the method further comprises controlling the processing of the current image region with the aid of a controller, using first data relating to a decoding of the current image region and second data relating to a decoding of a neighboring image region.

Such a controller makes it possible to refine the processing implemented by the boundary smoothing module, and in particular makes it possible to take into account possible differences between data relating to decoding on either side of the boundary, for example possible differences between the quantization parameters (QP) associated with the current image region and with the neighboring image region.

A computer program is also provided, comprising instructions for implementing the above method when this program is executed by a processor.

Also provided is a non-transitory computer-readable storage medium on which is stored a program for implementing the above method when this program is executed by a processor.

Also provided is a digital signal comprising at least one encoded current image region as well as metadata relating at least to a boundary between the current image region and a neighboring image region.

The digital signal is a signal that may in particular be transported over a communication channel, stored in a memory, or read by a processor. The encoded current image region can be decoded by a suitable decoder.

The metadata may be used for processing the decoded current image region, at least at the aforementioned boundary. In some examples, the metadata relates to at least one aspect of a smoothing to be applied at the boundary.

Example aspects of a smoothing to be applied at the boundary include the following:
activation of smoothing, or
adjustment of the smoothing strength, or
choosing a smoothing function from a set of predetermined smoothing functions.

In general, the aspects considered may concern a delimiting of one or more image regions where smoothing is to be implemented and/or a manner of implementing the smoothing in one or more regions among the delimited regions.

A data processing circuit is also proposed, comprising:
an input interface configured to receive the aforementioned digital signal, and
at least one output interface configured to provide the encoded current image region as input to a decoding loop, and to provide the metadata to a processing module provided at the exit of the decoding loop.

The data processing circuit may indiscriminately be integrated in a single device or may be formed of physical modules distributed across a plurality of devices placed in a communication network.

The decoding loop may or may not be part of the data processing circuit; the same is true for the processing module. The processing module is configured at least to process the metadata, i.e., for example to read the metadata, store it, modify it, relay it, erase it, etc. In some examples, the processing module is configured to use the metadata as an indication in guiding the implementation of a smoothing operation on a boundary between neighboring image regions contained in the digital signal.

The output interface may further be configured not to provide the metadata to the decoding loop.

### BRIEF DESCRIPTION OF DRAWINGS

Other features, details and advantages will become apparent upon reading the detailed description below, and upon analysis of the attached drawings, in which:

FIG. 1 schematically represents an example of an encoder according to the HEVC standard.

FIG. 2 represents an example of subdividing an image according to the VVC standard.

FIG. 3 represents three images in a decoded image sequence, with a deblocking filter implemented only at the decoder, in the decoding loop.

FIG. 4 represents an encoding of an image region according to one exemplary embodiment.

FIG. 5 represents a decoding of an encoded image region according to one exemplary embodiment.

FIG. 6 represents an encoder comprising four independent encoding cores, according to one exemplary embodiment.

FIG. 7 represents a decoder configured to decode four encoded image regions according to one exemplary embodiment.

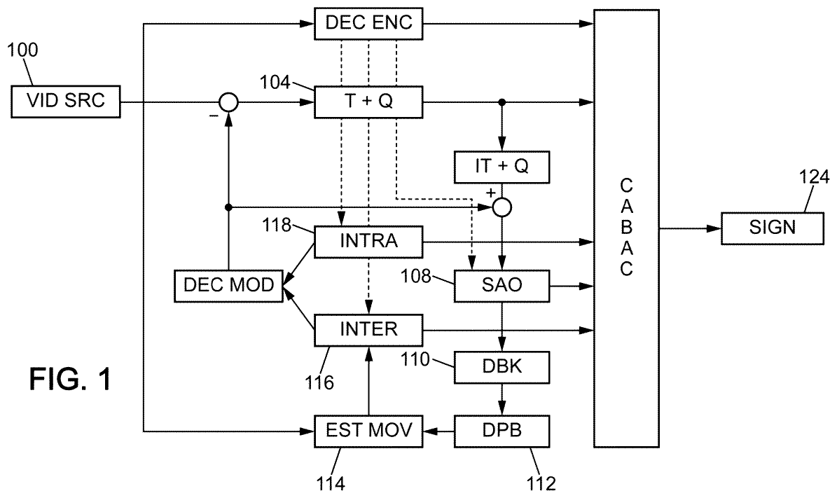

### DETAILED DESCRIPTION

The proposed technique aims to solve the problems described above, by introducing a normative smoothing of image region boundaries that result from a high-level partitioning of the image. This smoothing aims, as in the traditional filtering used in conventional video compression formats, to attenuate potentially visible boundaries between image regions such as Tiles, Slices, or sub-images.

The smoothing carried out by the proposed technique has the distinctive characteristic of being executed outside the coding loop. The image regions stored in the DPB and which serve as a reference for the image regions to be coded in the future do not benefit from the proposed smoothing and the resulting visual attenuation of the boundary. This makes it possible to apply the smoothing of image region boundaries only on the decoder side. Indeed, as the reconstruction operation on the encoder side is limited to generating the same images which will be stored in the DPB on the decoder side, the smoothing of boundaries of the sub-images does not take place there.

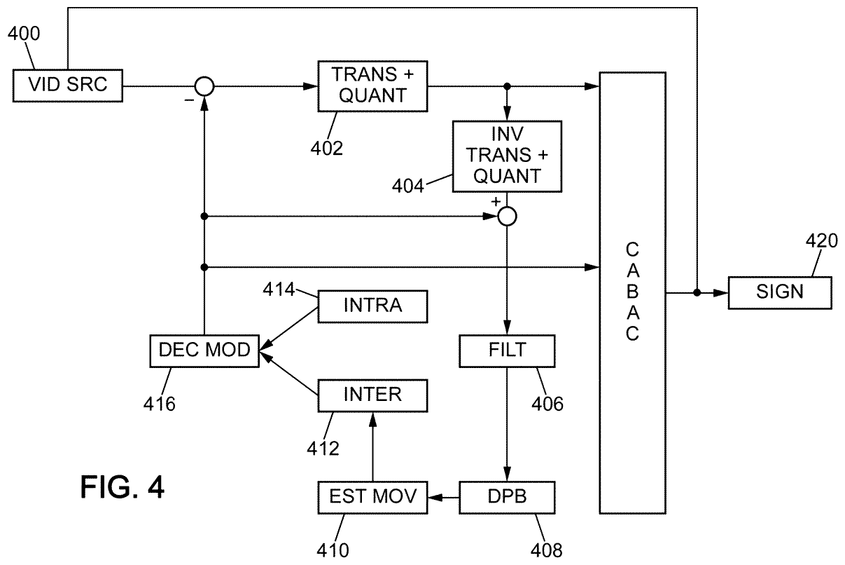

One particular exemplary embodiment is now described with reference to FIG. 4 which schematically represents an encoder.

A video sequence to be encoded 400 is provided in the form of a digital signal input to the encoder. The video sequence to be encoded comprises a plurality of images. These images are considered as having been the subject of a high-level partitioning, not shown, into image regions. The encoder is configured to process sequentially the image regions contained in the video sequence. It may be provided that, for a given image, the encoder first processes, for example, a first image region located at the top left of the image, then a second image region, for example adjacent to the first, and so on until processing a last image region, located for example at the bottom right of the image.

One distinctive characteristic of the proposed technique is that: the video sequence to be encoded also includes metadata, in addition to the image regions to be encoded, and/or this metadata is made accessible by a separate digital signal associated with the video sequence to be encoded.

The metadata may relate to the entirety of the boundaries between image regions of a given image or of several given consecutive images. Alternatively, the metadata may relate to one or more particular boundaries. Specific examples of metadata are presented below in connection with their intended use.

In the remainder of the description, we focus on processing a current image region provided as input to the encoder. We also assume that the metadata relates at least to a boundary between the current image region and at least one neighboring image region.

The processing of a current image region provided as input to the encoder includes a prediction of the current image region based on image regions previously encoded then decoded and stored in a memory 408. More specifically, the prediction of the current image region may be an intra prediction 414 that is implemented based on one or more previously processed regions of the same image. Prediction of the current image region may also be an inter prediction 412 implemented on the basis of an estimation 410 of a motion vector, which itself is implemented on the basis of regions of one or more previously processed images. Alternatively, it is also possible to implement in parallel an intra prediction 414 and an inter prediction 412 as described above, and to provide the results of these predictions to a decision module 416. Prediction of the current image region is then a prediction according to a prediction mode chosen by decision module 416.

The result of the prediction of the current image region is then compared to the current image region provided as input to the encoder, and the difference, referred to as residual pixels, is subjected to transformation and quantization 402. The current image region is then ready to be encoded. To do so, an entropic encoder 418, i.e. lossless, for example of the CABAC or CAVLC type, is supplied all the information needed to perform the encoding, namely:
an indication of the prediction mode selected to perform the prediction of the current image region (i.e. intra, inter, or a prediction mode chosen by the decision module),
prediction information according to the chosen mode, for example a motion vector in the case of an inter prediction mode, or an intra prediction function in the case of the intra mode, and
the result of the transformation and quantization of the residual pixels.

The same information is used to decode the current image region. An inverse quantization followed by an inverse transformation 404 of the transformed residual pixels is implemented, which makes it possible to reconstruct the residual pixels before transformation. The reconstructed residual pixels and the result of the prediction of the current image region are then added in order to reconstruct the current image region. Various filterings 406 may optionally be implemented. Finally, the reconstructed and optionally filtered current image region is stored in memory 408 and may now be used for implementing future inter predictions, within the framework of processing future image regions.

As thus described, the processing of the current image region comprises implementing a coding loop defined as a sequence of processing operations, based on processing operations on at least one previous image region and making it possible to supply information to the processing operations of at least one subsequent image region. Specifically, the current image region is first predicted on the basis of previously processed image regions, therefore processing operations on the current image region that are based on processing operations on at least one previous image region. From this prediction, the determination of the information necessary for coding the current image region can be made. This information is used to determine the result of decoding the encoded current image region. Finally, this result is stored in memory for the purpose of processing one or more subsequent image regions, therefore processing operations on the current image region which make it possible to supply information to the processing operations for at least one subsequent image region.

At the end of processing the current image region, entropic encoder 418 outputs a binary signal 420 comprising the current image region in encoded form. More generally, at the end of processing video sequence 400 provided as input to the encoder, binary signal 420 that is output from the entropic encoder comprises, in encoded form, all regions of all images in video sequence 400.

One distinctive characteristic of the proposed technique is that binary signal 420 is enriched with the aforementioned metadata which, as specified, relates at least to a boundary between the current image region and at least one neighboring image region. In any event, this metadata is not processed by the coding loop, i.e. it is not used within the coding loop in any of the processing operations serving as a basis for determining the encoded current image region or any other encoded image region. Optionally, this metadata is not made accessible to the coding loop and is only provided to a post-processing module (not shown) which incorporates it or joins it to the binary signal coming from entropic coder 418.

According to the proposed technique, this metadata is a form of signaling from the encoder to a smoothing module located outside the decoding loop for the purpose of smoothing a boundary between two neighboring image regions. The smoothing module is described below.

Referring to existing video coding standards, any signaling from an entity on the encoder side to an entity on the decoder side must be done via a particular message format for messages conveyed by the binary signal containing the encoded video sequence. These messages are called “supplemental enhancement information” or SEI. Taking into account the SEIs on the decoder side is optional and is intended to offer new functionalities conveyed by these SEIs. It is possible to edit the standards in the SEI portions at a later time. For example, the standard corresponding to VVC includes a separate document nplcit5 relating to the SEI portion of the standard.

By not being limited to existing video coding standards, the signaling possibilities are more extensive and are not limited to SEIs. The signaling may thus be implemented at the image sequence level via one or more headers associated with the sequence, such as SPS, PPS, or VUI. The signaling may also be implemented at the image level via one or more headers associated with the image, of the “slice header” or “picture header” type. In certain examples where the coding information is made accessible to the smoothing module, the signaling may also be implemented at the image regions located one on either side of a boundary between neighboring image regions.

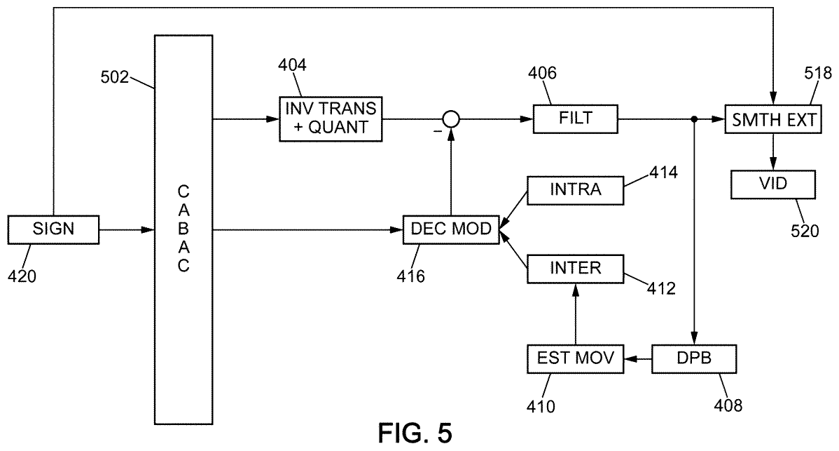

Reference is now made, in one exemplary embodiment, to FIG. 5 which schematically represents a decoder adapted to decode the aforementioned binary signal 420.

The decoder comprises an input interface configured to receive the binary signal. The encoded images, and more precisely the encoded image regions contained in the binary signal, are provided as input to an entropic decoder 502 and are successively processed by the entropic decoder. For example, the implementation, by the entropic decoder, of the processing of the encoded current image region generates two types of information as output from the entropic decoder, namely:
the residual pixels resulting from transformation and quantization 402 at the encoder, and
the prediction mode as well as the prediction information used at the encoder in order to predict the current image region.

This information is processed by a decoding loop operating in the same manner as the aforementioned encoding loop, in that it relies on one or more previously decoded image regions in order to decode the current image region. After its decoding, the current image region is stored in a memory 408 and is in turn used to decode one or more subsequent image regions. The image regions stored in memory 408 form a sequence of decoded image regions which can be aggregated, image by image, to form an image sequence, i.e. a decoded video sequence.

One distinctive characteristic of the proposed technique is that the decoded current image region is sent to a boundary smoothing module 518, more simply referred to hereinafter as a “smoothing module”, located outside the decoding loop. The smoothing module also receives the metadata contained in the binary signal 420 and/or associated with the binary signal. The metadata may relate to any aspect of the processing implemented by the smoothing module. For example, the metadata may be indicative of smoothing being activated for all boundaries between image regions or, conversely, for only certain specific boundaries. The smoothing module then implements boundary smoothing, limited to these particular boundaries. For example, the metadata may be indicative of a smoothing strength that may be common to all boundaries between image regions or may be differentiated by boundary. The smoothing module then implements smoothing for each respective boundary, in accordance with the smoothing strength respectively indicated. For example, the metadata may be indicative of a smoothing function to be implemented among a set of predefined smoothing functions. A Gaussian filter is one example of a filter that can implement a smoothing function. The metadata may thus be indicative, for one or more given boundaries, of a particular smoothing function to be implemented and/or of a particular value of a parameter that enters into the definition of the smoothing function. Considering a function implemented by a Gaussian filter as a smoothing function, the number of taps is one example of an appropriate parameter.

Smoothing module 518 uses the metadata relating to smoothing of the boundary between the current image region and a neighboring image region, in order to implement a smoothing of this boundary. The smoothing module thus outputs at least a decoded and smoothed current image region.

In the example shown, the smoothing module receives the decoded video sequence formed of a sequence of decoded images, one of these decoded images containing the decoded current image region. The smoothing module uses the metadata to process the video sequence and thus outputs a decoded video sequence 520 that is modified at least in that the decoded current image region is also smoothed.

Another distinctive characteristic of the proposed technique is that the result of smoothing one or more regions of one or more images, obtained as output from smoothing module 518, is not provided to the decoding loop and is not used to decode subsequent image regions. The proposed technique therefore makes it possible to achieve a visual rendering after decoding that is devoid of visible boundaries that are irritating to end users, while avoiding any passing on of pixels or other coding information between sub-images on the encoder side, which is welcome in coding techniques that use separate encoding cores which each process a sub-image in parallel. Indeed, the limitations in terms of connectors make data transfers between encoding cores expensive with such architectures.

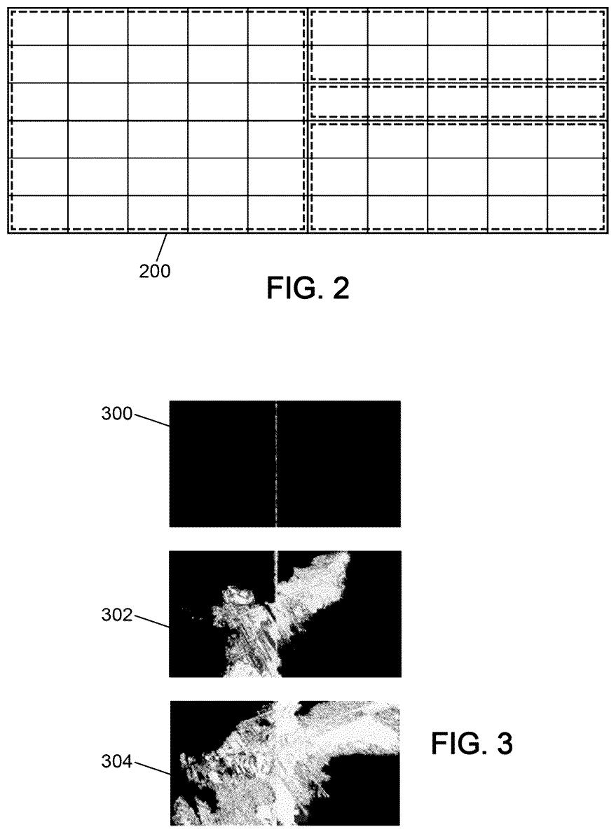

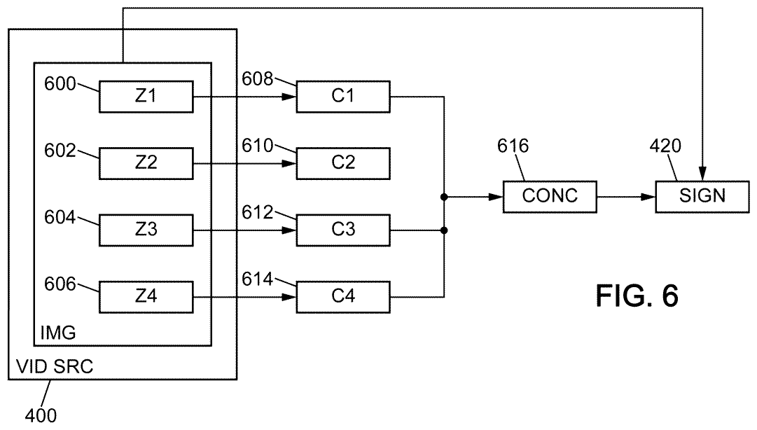

By way of illustration, FIG. 6 shows an example of encoding an image contained in a video sequence 400 to be encoded, the image being divided into four sub-images 600, 602, 604, 606. Video sequence 400 to be encoded is associated with, or comprises, metadata relating to at least one boundary between a sub-image 600 being considered and a neighboring sub-image 602. Encoding of the image is implemented in parallel by four separate encoding cores 608, 610, 612, 614. The processing of a given image region 600 by a given encoding core 608 comprises implementing a coding loop specific to the given encoding core 608. This means in particular that each encoding core 608 has its own storage memory, configured to store the image regions encoded at this encoding core 608. Each encoding core operates independently, without any sharing of data between encoding cores. The outputs from the four encoding cores are concatenated 616 so as to generate the binary signal 420 comprising the four sub-images in encoded form. This binary signal is also enriched with the metadata associated with, or included in, video sequence 400 to be encoded. Unlike a method that would implement smoothing in the decoding loop on the decoder side but without implementing smoothing on the encoder side, the proposed technique has the advantage of being completely normative and of avoiding drifts such as those illustrated in FIG. 3.

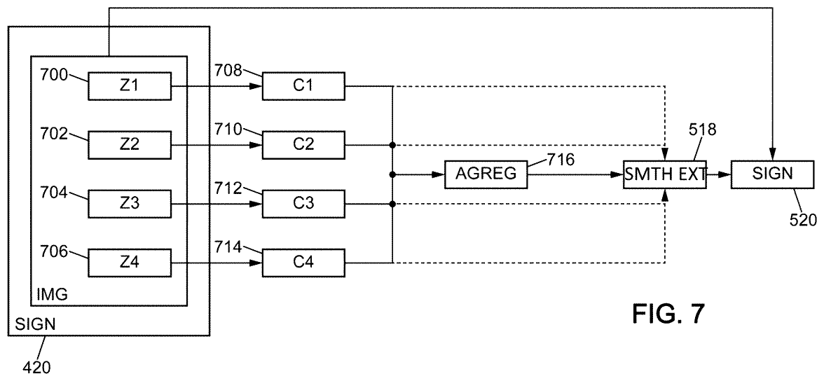

Reference is now made to FIG. 7, which illustrates one example of a decoder adapted for decoding encoded image regions 700, 702, 704, 706 of a same image contained in a binary signal 420. This decoding may be implemented, indiscriminately, in a parallel manner by a plurality of decoding cores 708, 710, 712, 714 or in a sequential manner by a single decoding core.

In this example, the decoded image regions are aggregated by an aggregator 716 so as to reconstruct, in decoded form, the image contained in binary signal 420 in encoded form. It is after this aggregation that the boundaries of the sub-images are smoothed.

The smoothing of a boundary between two neighboring image regions located on either side of the boundary is implemented by smoothing module 518 located outside the decoding loop. As has already been described, the smoothing module relies at least on the metadata for this.

Optionally, it may be provided that smoothing module 518 has access to the coding information of these neighboring image regions. This coding information may be provided for example by the decoding cores that have decoded these image regions, directly or indirectly. This is not always possible, however, in particular due to system constraints. For example, it is conceivable that, as with the encoder, the sub-images are each decoded in a separate decoding core, and that, once a sub-image has been decoded by a decoding core based on the corresponding part of the binary signal, the coding information relating to this sub-image is no longer available.

It may be provided that, when smoothing module 518 has access to the coding information, it uses this to control the implementation of the smoothing. This allows, for example, the smoothing module to implement a standardized deblocking filter, since, according to current standards, such a deblocking filter uses information such as the size of the transforms, the coding mode (inter/intra in particular), the QP or the motion vectors (in the case of inter coding), to determine the length and power of the smoothing.

Smoothing module 518 may of course be configured to implement any other smoothing function capable of using all or part of this coding information to control the implementation of the smoothing. One simple example of an applicable smoothing function would be a Gaussian function in which the standard deviation would depend on the QP of the image regions one on either side of the boundary to be smoothed.

Two particular exemplary embodiments are now described.

In a first particular exemplary embodiment, a source image is partitioned into several sub-images which are each encoded. The term “sub-image” is to be understood here as equivalent to the term “sub-picture” defined in the VVC video coding standard described for example in nplcit6. The sub-images are indicated through headers as being completely independent, in particular at the smoothing level. In other words, in the coding loop, no normative smoothing is performed across the boundaries between sub-images. Several encoding cores are provided to process, in parallel, the encoding of the sub-images. The encoding of a sub-image is implemented completely independently in an encoding core, without any pixel sharing between encoding cores. At the end of encoding the sub-images, a binary signal comprising the encoded sub-images is generated. The binary signal further comprises an SEI which contains a numerical value.

The binary signal is received at the decoder. The encoded sub-images are each decoded independently in a separate decoding core. After exiting the decoding cores, the decoded sub-images are aggregated into an image. The coding information about the blocks constituting the sub-images is not transmitted after exiting the decoding cores. After aggregating the sub-images and before reconstructing the image, an out-of-loop smoothing of the boundaries between sub-images is implemented. This smoothing does not use any coding information about the blocks constituting the sub-images, because this information is not made accessible by the decoding cores. Implementation of the smoothing in question uses a simple five-tap Gaussian filter in which the standard deviation, which determines the smoothing power, is set to the numerical value contained in the SEI. The smoothing power is thus identical for any of the smoothed boundaries and for any of the images.

In a second particular exemplary implementation, an image is partitioned into several “tiles”, the latter term being defined in the HEVC coding standard and described in nplcit7 in particular. The tiles are associated, via headers, with indications that no smoothing of the boundaries between tiles in the coding loop is to be implemented.

The encoding (HEVC) of each tile is implemented independently in a separate encoding core. In this second particular exemplary embodiment, constraints provide that no sharing of pixels or information is implemented between encoding cores. Such constraints ensure that the encoding/decoding of each tile is independent of the encoding/decoding of the other tiles, and fall within the concept of MCTS, already described.

As has already been explained, the encoding of a tile includes a prediction of the tile, which may comprise an intra prediction and/or an inter prediction. In particular, the prediction of the tile may comprise a prediction of a motion vector, for example in an inter or “merge” coding mode, these coding modes both being defined in the HEVC standard.

A first example of a constraint concerns the prediction of the motion vector: it involves asserting that, when predicting a current tile, the prediction of the associated motion vector points to this current tile.

A second example of a constraint concerns the “merge” coding mode, for which a list of candidates is provided for the purpose of predicting a motion vector for a current tile: it then involves providing only those candidates where the prediction of the motion vector for the candidate points to the current tile. Furthermore, a candidate denoted “TMVP” for “temporal motion vector predictor” is typically provided, this TMVP candidate relating to a previously coded image. However, it is possible that the TMVP candidate relates to a tile having a different location, in the previously coded image, than that of the current tile in the current image. In other words, in such a case, the current tile and the tile to which the TMVP candidate refers are processed by separate encoding cores. One possibility is then to prohibit selecting this TMVP candidate, in order to avoid any exchange of vectors, or more generally of information, between encoding cores.

Tile decoding is implemented serially in a single decoding core. The decoded tiles are then aggregated into an image. After aggregation and before reconstructing the image, an out-of-loop smoothing of the boundaries between tiles is performed. This smoothing uses all the block coding information, made available by the single decoding core. The out-of-loop smoothing is implemented by a deblocking filter for which the operation is defined in the HEVC standard and which relies on one or more SEI messages relating to boundaries between the blocks, and consequently relating to the boundaries between tiles.

For the purposes hereof, the following non-patent documents are cited:

nplcit1: Y.-K. Wang et al., “The High-Level Syntax of the Versatile Video Coding (VVC) Standard,” in IEEE Transactions on Circuits and Systems for Video Technology, vol. 31, no. 10, pp. 3779-3800, October 2021, doi: 10.1109/TCSVT.2021.3070860

nplcit2: WU, Yongjun, SULLIVAN, Gary J., ZHANG, Yifu, Motion-constrained tile set for region of interest coding, WO/2014/168650

nplcit3: Hendry, S. Hong, J. Chen, Y.-K. Wang (Huawei), JVET-N0109, CE12/AHG12: Treating boundaries of independent tile groups as picture boundaries, March 2019

nplcit4: S. Cho, H. Kim, H. Y. Kim and M. Kim, “Efficient In-Loop Filtering Across Tile Boundaries for Multi-Core HEVC Hardware Decoders With 4 K/8 K-UHD Video Applications,” in IEEE Transactions on Multimedia, vol. 17, no. 6, pp. 778-791, June 2015, doi: 10.1109/TMM.2015.2418995

nplcit5: Singh, S., Sharma, R. K., & Sharma, M. K. (2012). Post-Processing Technique to Reduce Tile Boundary Artifacts in JPEG2000 Compressed Images. The International Journal of Multimedia & Its Applications, 4(1), 127

nmplit6: Schwartz, E. L., Berkner, K., & Gormish, M. J. (1999). Optimal tile boundary artifact removal with CREW. In Proc. of Picture Coding Symposium. (pp. 285-288)

nplcit7: SO/IEC CD 23002-7 Supplemental enhancement information messages for coded video bitstreams

nplcit8: H.266: Versatile video coding https: //www.itu.int/rec/T-REC-H.266

nplcit9: ITU-T H.265, High efficiency video coding https://www.itu.int/ITU-T/recommendations/rec.aspx?rec=14107&lang=en

nplcit10: Y. He, M. Coban, M. Karczewicz, “AHG9/AHG13: Film grain blending process for film grain characteristics SEI message”, JVET-Y0053, January 2022.

1-9. (canceled)

10. A method for processing at least one decoded image region, the method comprising:
at the exit of a decoding loop that has decoded at least one current image region, processing the decoded current image region with the aid of a boundary smoothing module using metadata relating at least to a boundary between the current image region and a neighboring image region, wherein the metadata relates at least to a choice of a smoothing function to be applied to the boundary, from a set of predetermined smoothing functions.

11. The method according to claim 10, wherein:
the decoded current image region comprises a bordering region corresponding to the boundary and a region distant from the boundary, and
the processing of the decoded current image region comprises a processing of the bordering region and does not comprise a processing of the region that is distant from the boundary.

12. The method according to claim 10, the method further comprising:
controlling the processing of the decoded current image region with the aid of a controller, using first data relating to a decoding of the current image region and second data relating to a decoding of a neighboring image region.

13. A non-transitory computer-readable storage medium on which is stored a program for implementing the method according to claim 10 when this program is executed by a processor.

14. A digital signal comprising at least one encoded current image region as well as metadata relating at least to a boundary between the current image region and a neighboring image region, wherein the metadata relates at least to a choice of a smoothing function to be applied at the boundary, from a set of predetermined smoothing functions.

15. The digital signal according to claim 14, wherein the metadata further relates to an activation of the smoothing, and/or to an adjustment of a smoothing strength to be applied at the boundary.

16. A data processing circuit comprising:
an input interface configured to receive a digital signal comprising at least one encoded current image region and metadata relating at least to a boundary between the current image region and a neighboring image region, wherein the metadata relates at least to a choice of a smoothing function to be applied at the boundary, chosen from a set of predetermined smoothing functions, and
at least one output interface configured to provide the encoded current image region as input to a decoding loop, and to provide the metadata to a processing module provided at the exit of the decoding loop.

17. The data processing circuit according to claim 16, wherein the output interface is configured not to provide the metadata to the decoding loop.
